(19) United States
(12) Patent Application Publication
(10) Pub. No.: US 2026/0328277 A1
(43) Pub. Date: Oct. 22, 2026

(54) TRANSMISSION DEVICE FOR A MOTOR VEHICLE

(71) Applicant: ZF FRIEDRICHSHAFEN AG, Friedrichshafen (DE)

(72) Inventor: Philipp EDER, Mauth (DE)

(73) Assignee: ZF Friedrichshafen AG, Friedrichshafen (DE)

(21) Appl. No.: 18/997,897

(22) PCT Filed: Jul. 27, 2023
(86) PCT No.: PCT/EP2023/070848

§ 371 Date: Jan. 23, 2025

(30) Foreign Application Priority Data
Jul. 29, 2022 (DE) 10 2022 207 819.5

(51) Int. Cl. F16H 48/24; F16H 48/08; F16H 48/30

(52) U.S. Cl. CPC F16H 48/24; F16H 48/30; F16H 48/08

(57) ABSTRACT

A transmission device (1) for a motor vehicle having a differential (2) which is connectable or connected to a side shaft (4) of the transmission device (1) by a differential side gear shaft (5) and having a coupling device (6) which is configured to selectively couple the side shaft (4) to the differential side gear shaft (5) or decouple the side shaft (4) from the differential side gear shaft (5). The coupling device (6) has a coupling element (7) which is movable between at least two coupling positions and which is provided for coupling between the side shaft (4) and differential side gear shaft (5) and for locking the differential (2).

### PRIORITY CLAIM

This is a U.S. national stage of application No. PCT/EP2023/070848, filed on Jul. 27, 2023. Priority is claimed on German Application No. 10 2022 207 819.5, filed Jul. 29, 2022, the content of which is incorporated herein by reference.

### BACKGROUND OF THE INVENTION

The invention is directed to a transmission device for a motor vehicle. The transmission device has a differential which is connectable or is connected to a side shaft of the transmission device, particularly to a wheel of the motor vehicle, by means of a differential side gear shaft. The transmission device has a coupling device which is configured to selectively couple the side shaft to the differential side gear shaft or decouple the side shaft from the differential side gear shaft.

Transmission devices for motor vehicles which have a coupling device to selectively couple a drive component of the transmission device to a driven component or disconnect the coupling are known in principle from the prior art. Such devices may also be designated or understood as “disconnect units” or “power disconnect units”. A more efficient operation can be ensured by decoupling, for example, in operating situations in which the side shaft or the wheel of the motor vehicle should not be actively driven. For example, the quantity of rotating parts that must be carried along by the motor vehicle in a mobile state can be reduced by the decoupling so that the efficiency of the motor vehicle can be improved.

It is further known from the prior art that a locking or bypassing of the differential is advantageous in various operating states. Such locking devices that can lock the differential usually require their own additional device so that separate actuating elements, actuators and the like must be provided for the coupling device and a locking device of this kind. This is disadvantageous as regards quantity of parts, assembly, required installation space and, therefore, costs and production resources.

### SUMMARY OF THE INVENTION

An object of the invention is to provide a transmission device for a motor vehicle which is improved over the prior art.

The disclosure is directed to a transmission device for a motor vehicle with a differential and a coupling device by means of which the coupling between a side shaft connected to the differential and a differential side gear shaft of the transmission device can be selectively produced or disconnected, i.e., the differential side gear shaft can be selectively coupled to or decoupled from the side shaft. The side shaft and the differential side gear shaft may both be constructed as individual shafts or shaft portions which can be coupled to one another or disconnected from one another by means of the coupling device. The side shaft is connected, for example, to a wheel of the motor vehicle. Accordingly, when the coupling device is opened or decoupled, there is no transmission of torque between the wheel or side shaft and the differential side gear shaft, which latter is coupled to the differential and, therefore, to the rest of the transmission device via the differential side gear.

Torque can be transmitted, for example, from a drive device to an input of the differential and, in accordance with the basic function of the differential, to the side shaft via the differential side gear and the differential side gear shaft or to two opposite side shafts via the differential side gears and the differential side gear shafts. In a diverging operating state, for example, a coast state, torque can also be introduced from the wheel into the transmission device via the side shaft when the coupling device is closed, for example, for recuperation. When the coupling device is open, there is no connection between the side shaft and the rest of the transmission device. Within the meaning of the present application, the terms “differential side gear shaft” and “differential side gear” denote the gear of the differential and the associated shaft by means of which the torque flow between the differential and the output is produced. Therefore, in general, the terms “differential gear” and “differential gear shaft” can also be used.

The invention is based on the insight that the coupling device has a coupling element which is movable between at least two coupling positions and which is provided for coupling between the side shaft and differential side gear shaft and for locking the differential. In other words, the transmission device according to the invention proposes utilizing the same coupling element for locking the differential and for the function of coupling between the side shaft and the differential side gear shaft. The coupling element can be moved for this purpose into different coupling positions in which the coupling element fulfills the different tasks. In this regard, at least two coupling positions can be provided in which, for example, a decoupling is provided between the side shaft and differential side gear shaft, and in at least a second coupling position a locking of the differential and a coupling between the side shaft and differential side gear shaft can be carried out. As will be described in the following, further coupling positions of the coupling element can be provided in order to illustrate different operating states of the transmission device.

Therefore, in contrast to other transmission devices known from the prior art, there is no need to stock separate systems for the coupling between the side shaft and differential side gear shaft and for a locking action on the part of the differential. Instead, the invention suggests providing a coupling element both for coupling between the side shaft and the differential side gear shaft and for the selective locking of the differential. Accordingly, also just one actuator is required to move the movable coupling element into the desired coupling position. This reduces production costs, quantity of parts and assembly costs because the coupling device, as such, can be constructed modularly, for example, and can be arranged at the rest of the transmission device. The actuator can be constructed in any manner in principle; for example, the coupling element can be moved pneumatically, hydraulically, electromagnetically or electromechanically, and the actuator can be configured to generate a corresponding movement.

As has already been described, the coupling element can be moved into different coupling positions in order to adjust or implement different states of the transmission device and coupling device. According to an embodiment of the transmission device, it can be provided that the coupling element decouples the side shaft from the differential side gear shaft in a first coupling position, particularly a disconnect position, particularly when the differential is open. The embodiment therefore provides that the side shaft is decoupled from the differential side gear shaft in the first coupling position, i.e., no torque can be transmitted from the side shaft to the differential side gear shaft, or vice versa. The first coupling position can be occupied when the differential is open, i.e., the coupling element is adjusted in such a way that a switching point between the side shaft and the differential side gear shaft is open, and a further switching point with which the differential is locked or lockable also remains open.

Further, the coupling element can be moved into a second coupling position, particularly into a coupling location, wherein the coupling element couples the side shaft with the differential side gear shaft in a second coupling position, particularly when the differential is open. The second coupling position, which can also be referred to as coupling location, provides that the coupling element produces the coupling between the side shaft and the differential side gear shaft. In this state, torque can be transmitted between the side shaft and the differential side gear shaft. The coupling location can be realized in particular when the differential is open; that is, the differential is not locked and can perform its usual function. In the coupling location, for example, a driving of the differential side gear shaft can be carried out via a drive device. To this end, torque can be delivered to the input of the differential, which torque can be transmitted via pinion gears to the differential side gear and, therefore, into the differential side gear shaft and, from there, into the coupled side shaft.

A further embodiment form of the transmission device can provide that the coupling element couples an input of the differential, particularly a differential carrier, to the side shaft and the differential side gear shaft in a third coupling position, particularly in a coupled locking position. The coupled locking position described above is therefore an operating state of the transmission device in which the coupling between the side shaft and the differential side gear shaft is produced and a locking of the differential or a bypassing of the differential is realized simultaneously. Accordingly, in this operating state, for one, the differential is bypassed and, for another, the side shaft is coupled with the differential side gear shaft. In this operating state, torque which is introduced into the differential can be transmitted directly to the output, for example, through the direct coupling between the differential carrier and the side shaft and differential side gear shaft, respectively. The differential action is blocked in this state. In the described state, for example, the coupling element can simultaneously close both switching points simultaneously, e.g., can simultaneously close a switching point which is provided for coupling the differential to the side shaft and differential side gear shaft, respectively, and the switching point which is provided for coupling between the side shaft and the differential side gear shaft. The two switching points can be arranged adjacent to one another in axial direction of the side shaft or differential side gear shaft.

The described coupling positions can be occupied as needed, i.e., can be moved one into the other from the different coupling positions as needed. For example, the movable coupling element can be moved sequentially into the individual coupling positions. The coupling positions can be arranged one behind the other, particularly linearly, for example, with respect to a rotational axis of the side shaft or of the differential side gear shaft. In other words, the coupling element can always be moved into the desired coupling position in order to realize the associated operating state. The three coupling positions described previously can be arranged in order of their designation; thus the coupling element can be moved, for example, out of the first coupling position into the second coupling position and from the second coupling position into the third coupling position, and vice versa. Of course, it is also possible to move out of the individual coupling positions in the opposite direction, for example, out of the second coupling position into either the third coupling position or the first coupling position. The described coupling positions can also be arranged and designated differently. In principle, the designations “first”, “second” and “third” coupling positions can be exchanged or changed as needed.

According to a further embodiment of the transmission device, it can be provided that the coupling device is arranged outside of the differential, particularly coaxial to the side shaft and/or the differential side gear shaft. Accordingly, the coupling device, particularly the movable coupling element, is not arranged inside of the differential in order to realize the locking effect in the latter and/or to produce or cancel the coupling between the differential side gear shaft and side shaft; rather, the coupling element is arranged outside of the differential, particularly outside of the (outer) differential carrier. This offers the advantage that the installation space inside of the differential need not be changed but, rather, the coupling device can be arranged or mounted, for example, within existing concepts for the differential. The coaxial arrangement with respect to the side shaft is particularly economical with respect to installation space and can be arranged or provided at existing side shafts.

The transmission device can be further developed such that the coupling element has a first toothing portion which meshes with a second toothing portion of the differential side gear shaft when the coupling element and differential side gear shaft are in a coupled state with one another, and the input of the differential has a third toothing portion which meshes with the first toothing portion or a fourth toothing portion arranged at the coupling element when the coupling element and the input of the differential are in a coupled state with one another.

In principle, the coupling element has a coupling which couples the coupling element to the side shaft in rotational direction or in circumferential direction such that the coupling element is linearly displaceably mounted on the side shaft in order to be able to be moved into the individual coupling positions. In order to produce the coupling between the coupling element and the differential side gear shaft and the differential, for example, the outer differential carrier, the transmission device has corresponding toothing portions. The above-described first toothing portion is provided at the coupling element and is used for the coupling between the coupling element and the differential side gear shaft. The differential side gear shaft has a second toothing portion corresponding thereto. Accordingly, when the coupling element is moved into the locking position, particularly the second coupling position, the first toothing portion or second toothing portion mesh such that the coupling element which, as was described above, is connected to the side shaft so as to be fixed with respect to rotation relative to it is also fixedly coupled to the differential side gear shaft.

When moving from the second coupling position into the third coupling position, i.e., from the coupled position into the coupled locking position, the third toothing portion which is provided in the input of the differential can be additionally coupled with the coupling element. To this end, the coupling element can have the first toothing portion configured such that it is also adapted for coupling with the third toothing portion. Alternatively, the coupling element can have a fourth toothing portion which is provided for meshing with the third toothing portion of the differential. Accordingly, the coupling element performs a dual function, namely, on the one hand, the selective coupling between side shaft and differential side gear shaft and, further, the selective additional coupling between side shaft and differential.

The coupling device, particularly the coupling element, can further have at least two identical toothing portions and/or at least two different toothing portions. As has been described, different switching points are operated with the same coupling element or different switching points can be closed individually or collectively. The different switching points can be realized by means of different toothing portions. The toothing portions may be constructed identically or differently.

For example, all of the toothing portions can be constructed as radial teeth or splines. It is also possible to construct at least one toothing portion as an axial toothing or face spline. The various toothing portions can be arranged on the same radii or radial positions or on different radii or different radial positions. Jaw teeth, particularly axial jaw teeth, which can also be realized, for example, by reach-throughs are also possible. To take a very simple example, all of the teeth are constructed on the same radius as radial teeth, and the coupling element can be moved in the manner of a sliding collar in axial direction parallel to the axis of rotation of the side shaft or differential side gear shaft in order to be able to move into the different coupling positions in which the toothing portions are brought into meshing engagement.

As was previously described, the coupling device can be constructed or formed separate from the differential in principle so that it can be mounted outside of and independent from the differential. The coupling device can be constructed modularly in particular and connectable or connected to a connection flange of the transmission. The coupling device can be constructed cylindrically in particular and inserted over a side shaft for mounting. The differential can have a connection flange in particular which allows the coupling device to be attached to the differential.

The coupling device can further have a spring device which is configured to build up a preloading force on the coupling element in at least one actuating direction in the event of a tooth-on-tooth condition of a toothing portion. In principle, a preloading force can be built up in any direction, for example, by means of corresponding spring elements which can act on the coupling element in both directions. Accordingly, depending on which teeth are to be brought into engagement, it can be provided that an actuator movement can be carried out continuously and this actuator movement leads to the preloading of the spring element of the spring device during the occurrence of a tooth-on-tooth condition, particularly when the coupling element is held stationary due to its pending meshing. The preloading is reduced when the tooth-on-tooth condition is resolved and the coupling element moves into the desired coupling position.

The spring device described above can be arranged particularly between the differential side gear shaft and the differential side gear. The spring device accordingly pushes the differential side gear shaft against the side gear in axial direction, i.e., parallel to the rotational axis of the differential side gear shaft. For example, when passing from the first coupling position, in which the coupling element is separated from the differential side gear shaft, into the second coupling position in which the coupling between the coupling element and differential side gear shaft is produced and when a tooth-on-tooth condition occurs in doing so, the differential side gear shaft can be displaced in direction of the differential side gear and the spring device can be compressed. Accordingly, the actuator moving the coupling element can advantageously be moved directly into its end position without additional sensors and without having occupy intermediate positions. When the tooth-on-tooth condition is resolved, the spring energy is reduced and the differential side gear shaft is accordingly moved into its original position, and the first toothing portion or second toothing portion is brought into engagement.

The spring device further advantageously carries out a further function, namely, during a movement out of the third coupling position into the second coupling position. The spring device moves the differential side gear shaft in direction of the side shaft or toward the coupling element so that the spring device actively prevents the coupling between the first toothing portion and the second toothing portion being unintentionally disengaged when passing out of the third coupling position into the second coupling position. In addition, the arrangement of the toothing portions or the overlapping can be selected in such a way that when passing from the second coupling state into the third coupling state a compression of the spring device, or at least of a spring element, is provided in order to bring the toothing portions in meshing engagement with the differential and the coupling element 7. Since the spring device is accordingly preloaded in the third coupling state, this spring device simultaneously supports the disengagement when passing from the third coupling state into the second coupling state.

Advantageous configurations of the invention are summarized in the following.

The end of the differential side gear on the side shaft side and of the differential carrier are advantageously arranged so as to be axially offset in the first coupling position and/or second coupling position and are arranged to axially overlap in the third coupling position. To this end, the teeth of the differential side gear and of the differential carrier are located preferably spatially adjacent to one another in the first coupling position and/or second coupling position.

The differential side gear is preferably arranged so as to be axially movable relative to the differential carrier. In particular, a restoring element, particularly a spring device, can be provided, by which a force can be applied to the differential side gear in direction of the side shaft. In particular, the restoring element can build up a preloading force on the coupling element opposite the actuating direction when changing from the first coupling position into the second coupling position when a tooth-on-tooth condition occurs. Further, the restoring element can build up a preloading force on the coupling element in disengaging direction when changing from the second coupling position to the third coupling position. In the former case, the restoring element is loaded only during a tooth-on-tooth position; in the second case, the restoring element is always loaded.

The coupling element and/or the differential side gear and/or the differential carrier preferably have a face spline.

The coupling element is advantageously mounted on the side shaft so as to be fixed with respect to rotation and axially displaceable relative to it. This results in a very compact construction.

Aside from the transmission device, the invention is directed to a motor vehicle which has an above-described transmission device. The motor vehicle has, for example, an electric machine which can be coupled with the input of the differential in order to generate torque which can be transmitted to the differential. Also, a recuperation of energy can be carried out with the above-described electric machine. All of the advantages, details and features which have been described with respect to the transmission device are applicable in their entirety to the motor vehicle.

### BRIEF DESCRIPTION OF THE DRAWINGS

The invention will be described in the following based on exemplary embodiments referring to the drawings. The drawings are schematic depictions and show:

FIG. 1 a schematic section of a transmission device for a motor vehicle in a first coupling state;

FIG. 2 a schematic sectional view of a transmission device according to a first embodiment example in a first coupling state;

FIG. 3 a schematic sectional view of the transmission device from FIG. 2 in a second coupling state;

FIG. 4 a schematic sectional view of the transmission device from FIGS. 2, 3 in a third coupling state;

FIG. 5 a schematic sectional view of a transmission device according to a second embodiment example in a first coupling state; and

FIG. 6 a schematic sectional view of the transmission device from FIG. 5 in a third coupling state.

### DETAILED DESCRIPTION OF THE PRESENTLY PREFERRED EMBODIMENTS

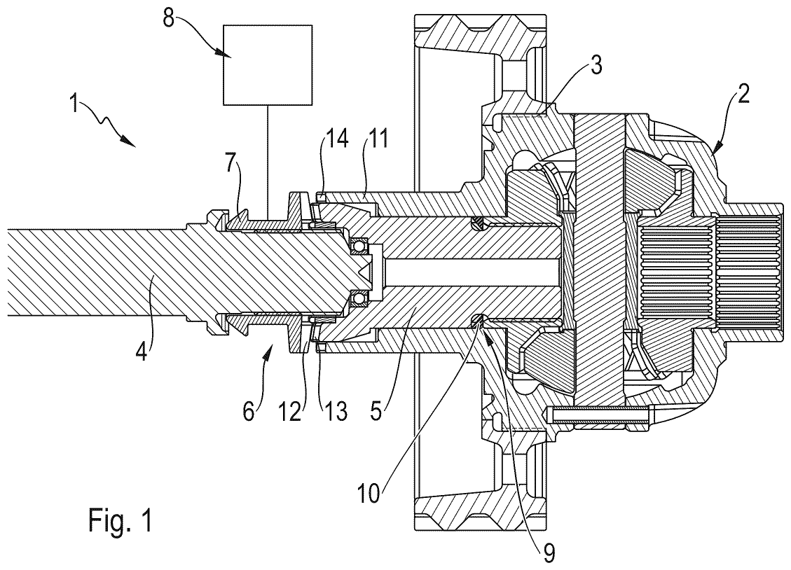

FIG. 1 shows a schematic section of a transmission device 1. The transmission device 1 is provided for a motor vehicle or is arranged in a motor vehicle. The motor vehicle is not shown for the sake of clarity. The transmission device 1 has a differential 2 which can be coupled or is coupled with a drive device, not shown in more detail, for example, an electric machine, via a differential input 3. The differential 2 is formed in a manner known per se to transmit or distribute torque introduced via the differential input 3 into the differential 2 to side shafts 4. For the sake of clarity, only one side shaft 4 is shown. The side shaft 4 is provided for coupling with a differential side gear shaft 5. The torque can be guided to a wheel of the motor vehicle via this side shaft 4. In other words, torque can be transmitted from the differential input 3 via the pinion gears to the differential side gears and, therefore, to the differential side gear shaft 5 and, depending on the coupling state, to the side shaft 4 and, therefore, to the wheel.

The transmission device 1 further has a coupling device 6 which provides a movable coupling element 7. The coupling element 7 is movable into different coupling positions, shown purely by way of example in FIGS. 1-6 , for example, via an actuator 8, for example, a pneumatic, hydraulic, electromagnetic or electromechanical actuator.

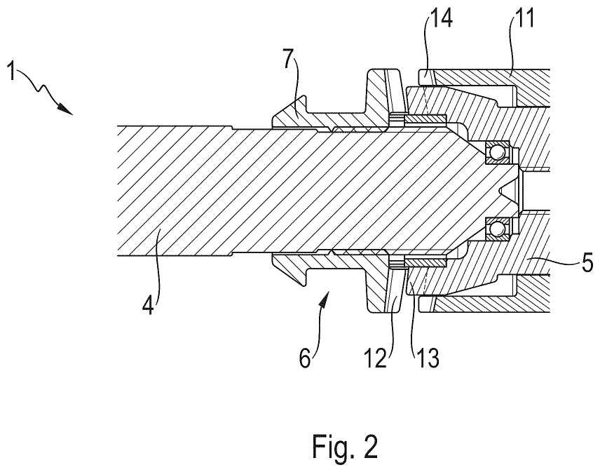

In the operating state or first coupling state shown in FIG. 1 as a schematic overview and in FIG. 2 as a schematic sectional view, the coupling element 7 is arranged schematically in a first coupling position or is adjusted into a first coupling position. The coupling device 6 further has a spring device 9 (see FIG. 1) which, in this embodiment example, has a spring element 10 which can exert a preloading force on the differential side gear shaft 5. The spring device 9 allows the actuator 8 to be brought into its position associated with the respective coupling position for producing the respective coupling position, particularly without stopping or monitoring the execution of the movement of the coupling element 7 with expensive sensors. The coupling element 7 is coupled with the side shaft 4 so as to be fixed with respect to rotation relative to it but so as to be movable in axial direction into the various coupling positions which are to be described in the following.

The differential side gear shaft 5 is disconnected from the side shaft 4 in a first coupling state shown in FIGS. 1, 2 so that no torque can be transmitted between the side shaft 4 and the differential side gear shaft 5. As will also be appreciated from FIGS. 1, 2, a second switching point is also opened between the differential 2, particularly a differential carrier, and the side shaft 4 so that a locking action of the differential 2 is not provided and the differential 2 is open.

When a so-called tooth-on-tooth condition occurs during the meshing of the teeth of the coupling element 7, for example, in a toothing of the differential side gear shaft 5 or the toothing of the differential 2 at a differential flange 11, the spring element 10 can be preloaded, and the differential side gear shaft 5 can be deflected in direction of the center of the differential 2. In particular, the spring element 10 is compressed between the differential side gear shaft 5 and the associated differential side gear. When the tooth-on-tooth condition is resolved, the toothing of the coupling element 7 can mesh in the respective corresponding toothing at the differential side gear shaft 5, and the differential side gear shaft 5 is restored to the initial position by the spring element 10.

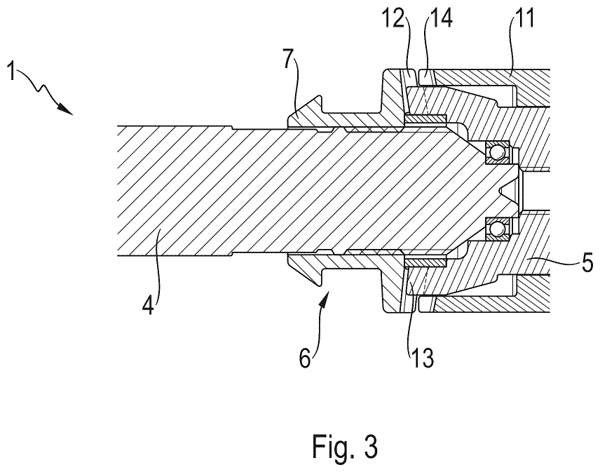

As has been described, the first coupling state of the transmission device 1 in which the coupling element 7 is moved into the first coupling position is shown in FIGS. 1, 2. In the first coupling position, it will be seen that the coupling between the differential side gear shaft 5 and the side shaft 4 is disconnected. The coupling element 7 has a first toothing portion 12 which is constructed as an axial toothing or face spline in the configuration shown in FIGS. 1-4 . Corresponding to this, the differential side gear shaft 5 has a second toothing portion 13 which can be engaged with the first toothing portion 12, namely, when passing from the first coupling position into the second coupling position. To this end, the coupling element 7 is displaced in axial direction, namely, from left to right in the illustrations, so that the first toothing portion 12 is brought into engagement with the second toothing portion 13 as is shown by way of example in FIG. 3.

The coupled (connected) position in which torque can be transmitted between the side shaft 4 and the differential side gear shaft 5 occurs in the second coupling position of the coupling element 7, i.e., the second coupling state, shown in FIG. 3. The differential 2 can operate in a manner known per se because it is not locked in the second coupling state.

The second coupling position shown in FIG. 3 can be moved into starting from the first coupling position shown in FIGS. 1, 2. To this end, the coupling element 7 is moved in direction of the differential 2 in axial direction with respect to the rotational axis of the differential side gear shaft 5 or side shaft 4 so that the first switching point in which the first toothing portion 12 and the second toothing portion 13 are engaged is closed.

In the second coupling position shown in FIG. 3, the second switching point, i.e., the switching point between the differential 2 and the coupling element 7, is open so that there is no locking action of the differential 2. Accordingly, in this embodiment example, the differential 2 can work as usual so that the torque that is applied to the differential input 3 can be distributed to the side shafts 4 and can be transmitted from the differential side gear shaft 5 to the side shaft 4.

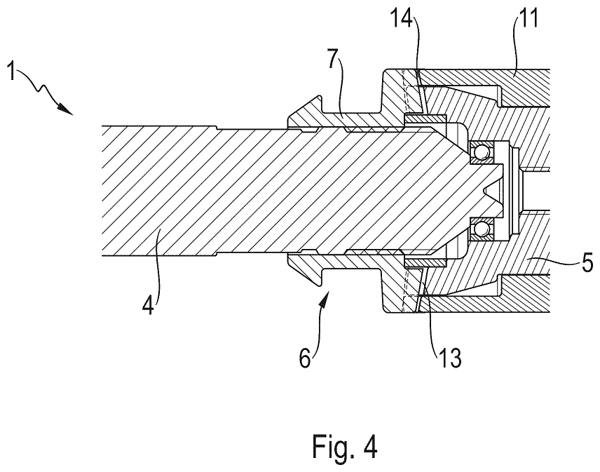

FIG. 4 shows the coupling element 7 in a third coupling position, i.e., the coupling device 6 is in a third coupling state. In the third coupling state, the coupling element 7, in addition to the second coupling position, also couples the differential input 3 of the differential 2, for example, the differential carrier, to the side shaft 4 via the differential flange 11. The side shaft 4, as previously described, is simultaneously coupled with the differential side gear shaft 5, namely, via the first switching point, i.e., the first toothing portion 12 and in the second toothing portion 13. In other words, in the third coupling position, the two switching points are closed simultaneously by the coupling element 7 so that, for one, the side shaft 4 and the differential side gear shaft 5 are coupled with one another and the differential 2 is simultaneously locked. The locking of the differential 2 is effected by bypassing the differential 2 through the coupling between the differential carrier at the side shaft 4.

To this end, the differential 2, in particular the differential flange 11, has a third toothing portion 14 which is also brought into engagement with the first toothing portion 12 at the coupling element 7 in the third coupling state. The third toothing portion 14 is accordingly also constructed as an axial toothing or face spline. The coupling element 7 can accordingly be produced in a particularly simple manner, since it has its own toothing portion, namely, the first toothing portion 12, which can serve both switching points. When moving from the second coupling state into the third coupling state, the fact that the differential side gear shaft 5 is supported at the differential side gear in a spring-loaded manner via the spring element 10 can also be made use of in particular. Further, to this end, a force can be exerted in axial direction on the differential side gear shaft 5 via the coupling element 7 so that the spring element 10 is compressed and the toothing portions 12, 14 can accordingly be brought into engagement. In the third coupling state, the spring element 10 can accordingly be preloaded so that when passing anew from the third coupling state into the second coupling state the disengagement can be assisted by reducing the spring energy of the spring element 10.

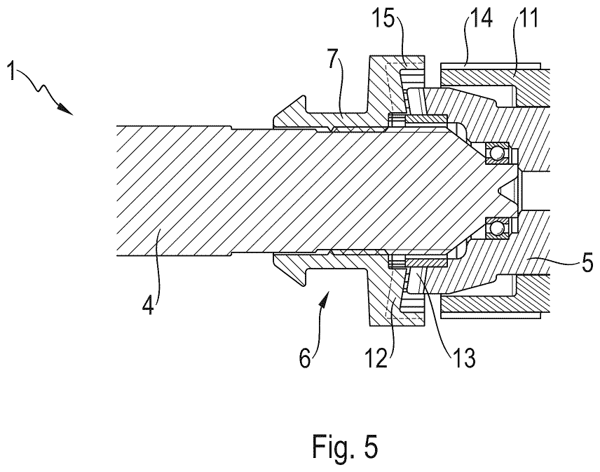

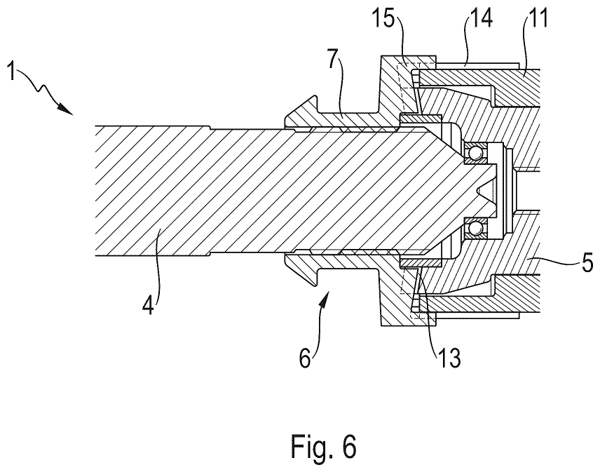

FIGS. 5, 6 show a further embodiment example of the transmission device 1. The basic construction of the transmission device 1 corresponds to that shown in the preceding FIGS. 1-4 . The basic functioning corresponds to the transmission device 1 described above, particularly with respect to the individual coupling positions or coupling states. Therefore, like reference numerals are used for like component parts. The preceding description is applicable in a corresponding manner.

In contrast to the preceding description, the coupling element 7 has a separate, fourth toothing portion 15 which is provided for coupling with the third toothing portion 14 of the differential flange 11 or of the differential 2. As can be seen, the third toothing portion 14 and the fourth toothing portion 15 are constructed in this embodiment example as splines, i.e., as radial teeth, the third toothing portion 14 being constructed as an external toothing at the differential flange 11 and the fourth toothing portion 15 being constructed as an internal toothing at the coupling element 7.

When passing from the first coupling position of the coupling element 7 shown in FIG. 5 into the third coupling position of the coupling element 7 shown in FIG. 6, the second coupling state in which the first toothing portion 12 is coupled with the second toothing portion 13 is initially occupied as has been described so that the side shaft 4 is coupled with the differential side gear shaft 5 via the coupling element 7. In a further movement of the coupling element 7 in direction of the differential 2, the third toothing portion 14 is also coupled with the fourth toothing portion 15 so that an additional locking action of the differential 2 is achieved.

The coupling device 6 can be constructed modularly, for example, as a cylindrical module which can be inserted via the side shaft 4 and connected to the housing of the differential 2, for example, in the region of the differential flange 11.

The advantages, details and features shown in the individual exemplary embodiments are combinable with one another, transferable to one another and exchangeable with one another as needed.

1. A transmission device for a motor vehicle, having a differential which is connectable or connected to a side shaft of the transmission device a differential side gear shaft, wherein the transmission device has a coupling device which is configured to selectively couple the side shaft to the differential side gear shaft or decouple the side shaft from the differential side gear shaft, wherein the coupling device has a coupling element which is movable between at least two coupling positions and which is provided for coupling between the side shaft and differential side gear shaft and for locking the differential.

2. The transmission device according to claim 1, wherein the coupling element decouples the side shaft from the differential side gear shaft in a first coupling position, particularly a disconnect position, particularly when the differential is open.

3. The transmission device according to claim 1, wherein the coupling element couples the side shaft with the differential side gear shaft in a second coupling position, particularly when the differential is open.

4. The transmission device according to claim 1, wherein the coupling element couples an input of the differential particularly a differential carrier, with the side shaft and the differential side gear shaft in a third coupling position, particularly in a coupled locking position.

5. The transmission device according claim 1, wherein the coupling positions of the coupling element are arranged linearly one behind the other, particularly with respect to a rotational axis of the side shaft or of the differential side gear shaft.

6. The transmission device according to claim 1, wherein the coupling device is arranged outside of the differential, particularly coaxial to the side shaft.

7. The transmission device according to claim 1, wherein the coupling element has a first toothing portion which meshes with a second toothing portion of the differential side gear shaft when the coupling element and differential side gear shaft are in a coupled state with one another, and the input of the differential has a third toothing portion which meshes with the first toothing portion or a fourth toothing portion arranged at the coupling element when the coupling element and the input of the differential are in a coupled state with one another.

8. The transmission device according to claim 1, wherein the coupling device, particularly the coupling element, has at least two identical toothing portions and/or at least two different toothing portions.

9. The transmission device according to claim 1, wherein the coupling device has a spring device which is configured to build up a preloading force on the coupling element in at least one actuating direction when a tooth-on-tooth condition occurs.

10. The transmission device according to claim 9, wherein the spring device is arranged between the differential side gear shaft and the differential side gear.

11. A motor vehicle comprising a transmission device according to clam 1.
